(19) United States
(12) Patent Application Publication
(10) Pub. No.: US 2026/0195763 A1
(43) Pub. Date: Jul. 9, 2026

(54) MACHINE LEARNING-BASED METHOD AND SYSTEM TO RETAIN CUSTOMERS

(71) Applicant: BOLD Limited, Hamilton (BM)

(72) Inventors: Kai JIN, Davis, CA (US); Ricardo DAVILA NIEVES, Toa Baja, PR (US); Gaurav SANDIL, Noida (IN); Saransh KHURANA, Panipat (IN)

(21) Appl. No.: 19/009,851

(22) Filed: Jan. 3, 2025

(51) Int. Cl. G06Q 30/01; G06Q 30/0202; H04M 3/523

(52) U.S. Cl. CPC G06Q 30/01; G06Q 30/0202; H04M 3/523

(57) ABSTRACT

Certain aspects provide a computer-implemented method for retaining customers of a company. The method receives a request to cancel a customer relationship with a company from a customer. The method forms a profile of the customer from features of the customer and a service report of the customer in response to the request to cancel. The profile is input to a classification model that generates a predicted-retention value (PRV), indicating a probability of retaining the customer based on the profile. If the customer is likely to be retained, the customer is connected to a customer service agent of the company for personalized service.

### BACKGROUND

### Field

Aspects of the present disclosure relate to machine learning.

### Description of Related Art

One of the largest customer retention challenges faced by companies is the fierce competition of the market. Customers typically have numerous options to choose from, and companies have to offer unique subscriptions or services to keep their customers engaged. Although companies recognize that preventing customers from switching to competitors is of central importance, many companies have adopted a one-size-fits-all strategy to try and retain customers who express a desire to cancel subscriptions or services. The typical process that a customer experiences when calling a company to cancel a subscription or a service begins with an interactive voice recognition (IVR) system that guides the customer through a series of menu options or questions to identify the reason for the call and routes the customer to an appropriate customer service agent. The agent's role is to handle the cancellation request and attempt to retain the customer according to a predefined script. The script is typically constructed on the assumption that many customers can be retained by simply presenting a discounted offer for a subscription or service while others who do not immediately accept the offer cannot retained. The scripts do not distinguish the myriad reasons customers have for wanting to cancel a subscription or service. As a result, many customers are lost that may have otherwise been retained. Consequently, there is a need for further improvements to retaining customers.

### SUMMARY

Certain aspects provide a computer-implemented method, comprising: obtaining a request to cancel a customer relationship with a company from a customer communicating with an interactive voice recognition (IVR) engine using an electronic device. The method uses a classification model to generate a prediction of whether the customer is receptive to customer retention efforts based on a profile of the customer. The method electronically connects the electronic device of the customer to a customer service agent of the company based on a prediction that the customer is receptive to customer retention efforts.

Other aspects provide an apparatus comprising: a customer interactive voice recognition (IVR) engine configured to authenticate an identify of a customer of a company and to guide the customer through a series of menu options or questions that detect a request to cancel a customer relationship with the company via an electronic device of the customer, wherein the electronic device is in electronic communication with the apparatus; a customer retention engine configured to, in response to the customer IVR engine detecting a request to cancel the customer relationship by the company, use a classification model to predict whether the customer is receptive to customer retention efforts based on information the company has retained about the customer; and a call transfer engine configured to electronically connect the electronic device of the customer to a customer service agent of the company in response to a prediction that the customer is receptive to customer retention efforts, thereby enabling the customer to communicate directly with the customer service agent.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example customer service operations architecture.

FIG. 2 depicts an example of creating a customer features data store and a service report data store.

FIG. 3 depicts an example flow diagram of operations performed by a customer retention engine.

FIG. 4 depicts an example of obtaining a profile for a customer.

FIG. 5 depicts an example of encoding a profile for a customer into an encoded profile.

FIGS. 6A-6C depict an example of using a decision forest to obtain a predicted-retention value (PRV) of a customer.

FIG. 7 depicts an example of using a neural network to obtain a PRV of a customer.

FIG. 8 depicts an example flow diagram of a method for predicting retention of a customer.

FIG. 9 depicts an example flow diagram using a classification model described in FIG. 8.

FIG. 10 depicts an example flow diagram of a determining PRV described in FIG. 8.

FIG. 11 schematically depicts an example computing device.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

As discussed, a traditional approach to interacting with customers who call a company to cancel subscriptions or services begins with an IVR system that leads to customer service agents who handle each cancellation request according to a standardized script. This one size fits all strategy for retaining customers creates the following technical problems.

First, the strategy fails to recognize the diverse reasons and motivations behind each customer's decision to cancel a subscription or service. As a result, the effectiveness of retaining customers is significantly diminished, leading to low customer retention rates.

Second, the lack of customization in the traditional retention strategies means that these strategies are not optimized for individual customer needs or situations. This inefficiency leads to missed opportunities to effectively persuade different types of customers to reconsider their decisions to cancel.

Third, the existing process requires every cancellation call to be routed to a customer service agent, who follows a standard script. This approach demands substantial human resources and time, especially when dealing with a high volume of calls, which makes the traditional approach to retention efforts an expensive and labor-intensive strategy for a company.

Fourth, the strategy can be frustrating for customers as the standardized scripts are limited and typically do not address the specific concerns or reasons for each cancellation. This can lead to a negative customer experience, further discouraging customers from maintaining an engagement with the company.

Certain aspects of methods, systems, and apparatuses described herein provide a data-driven technical solution to the above-described technical problems by tailoring the retention strategy to individual customer profiles, thereby significantly improving customer retention, reducing operational costs for a company, and enhancing customer satisfaction.

Novel aspects include training and using a machine learning-based classification model that is able to predict which customers who attempt to cancel subscriptions or services are likely to be retained based on each customer's own individual profile. In particular, the classification model relies on predictive analytics to determine a probability, called a “predicted-retention value (PRV),” that a customer is receptive to retention efforts. If the PRV indicates a likely retention of the customer, the customer is directed to a live customer service agent who provides the customer with a personalized customer experience in accordance with the customer's profile. On the other hand, if the PRV indicates the customer is unlikely to be receptive to retention efforts, the customer's relationship with the company can be canceled via an IVR system.

Methods, systems, and apparatuses described herein have a number of technical advantages over the traditional one-size-fits-all strategy described above.

First, predictive analytics are used to classify customers based on profiles of customers and accurately predict which customers are likely to cancel their subscriptions or services and which customers express a desire to cancel but are actually open to retention efforts. The customers that are classified as being open to retention efforts receive a more targeted approach to retention from a customer service agent as compared to the traditional one-size-fits all strategies of treating all customers the same.

Second, methods, systems, and apparatus described herein leverage a machine learning classification model that enables a company to dynamically personalize the retention offer for each customer based on each customer's profile, which increases the likelihood of retention.

Third, the process of determining a PRV is automated for each customer who submits a request to cancel a subscription or service, which significantly reduces the need for customer service agents to handle every cancellation call and translates into significant cost savings for the company in terms of labor and operational expenses.

Fourth, the innovation promises a more seamless and customer-friendly experience by minimizing unnecessary steps. Customers with a low likelihood of retention are not subjected to a potentially frustrating retention processes, while customers with a higher likelihood of retention are connected to customer service agents who are better equipped to handle their specific concerns.

Fifth, customer service agents can focus their time and expertise on customers who have a higher probability of being retained, thus optimizing the use of human resources.

Sixth, the continuous machine learning aspect of the classification model ensures that the system adapts over time, using new data to refine the predictive capabilities of the model and retention strategies.

By addressing the technical problems of current approaches to customer retention, the methods, systems, and apparatuses described herein not only improve the efficiency of the retention process but also significantly enhance each customer's level of satisfaction and impression of the company.

### Example Method for Using Machine Learning to Retain Customers

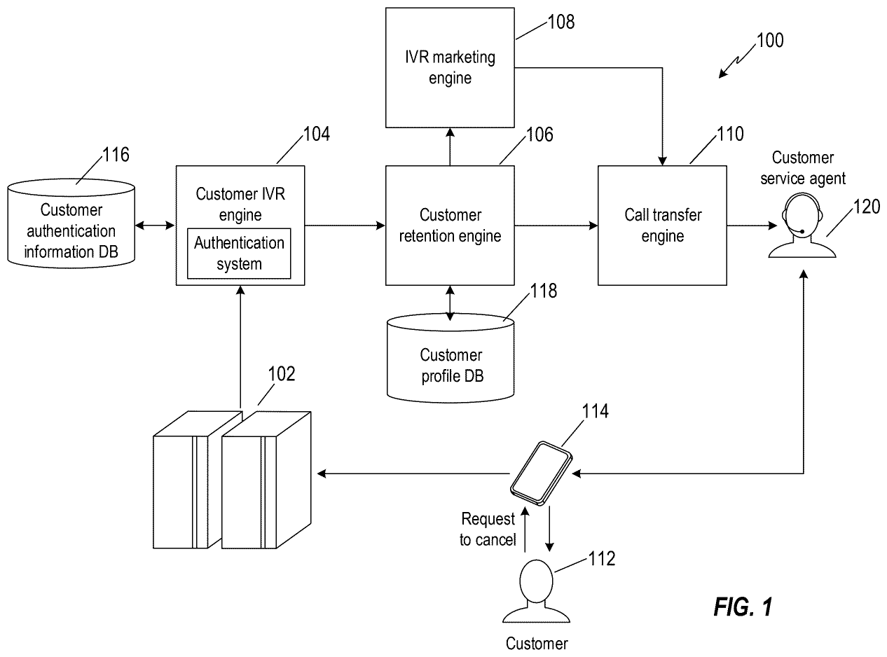

FIG. 1 depicts an example customer service operations architecture 100. The architecture 100 is executed on a computer system 102 operated by a company that sells to customers one or more of products, subscriptions, and/or services. The architecture 100 executes operations for interacting with customers who submit requests to cancel customer relationships with the company. A customer relationship includes any one or more of purchasing items, purchasing a subscription, purchasing a service, access to marketing channels, and other customer interactions with the company. In this example, the architecture 100 includes a customer interactive voice recognition (IVR) engine 104, a customer retention engine 106, an IVR marketing engine 108, and a call transfer engine 110.

A customer 112 who desires to cancel a customer relationship with the company can connect to and electronically communicate with the architecture 100 via any one of many different types of electronic devices and communication tools (e.g., mobile provider, web conferencing application, or a chat bot). For example, in certain aspects, the customer 112 can connect with the architecture 100 via a web browser of a desktop computer, a laptop, or a tablet or the customer 112 can connect via a mobile device 114 that enables the customer to dial a customer service number of the company. In certain aspects, the customer 112 can connect with the architecture 100 via a web conferencing application, such as Zoom™, Google Meet™, or Microsoft® Teams®. In certain aspects, the customer 112 can connect with the architecture 100 via a chat bot that enables the customer 112 to converse with the architecture 100 by typing a message or speaking through a user interface.

The customer IVR engine 104 configured to communicate by voice detection or in writing with the customer. The customer IVR engine 104 includes an authentication system that guides the customer 112 through a series of questions to verify the identity of the customer 112. For example, the authentication system may ask the customer 112 to enter one or more types of customer authentication information, such as the customer's personal identification number (“PIN”), a security code sent from the customer IVR engine 104 to the mobile device 114, the customer's account number, and the customer's personal address. The customer IVR engine 104 retrieves the customer's authentication information from a customer authentication information database 116 and compares the customer authentication information entered by the customer with the customer authentication information obtained from the customer authentication information database 116. If the customer authentication information entered by the customer matches the customer authentication information obtained from the customer authentication information database 116, then the customer 112 is connected to the customer retention engine 106. Otherwise, the customer 112 is notified that the information submitted by the customer is incorrect and the customer 112 is permitted to try again or may be disconnected from the architecture 100.

Once the customer's identity has been verified by the authentication system, the customer IVR engine 104 guides the customer through a series of menu options or questions that are able to detect a reason for the customer to contact the company. The customer IVR engine 104 engages the customer retention engine 106 in response to the customer indicating the reason for the contacting the company is to cancel the customer relationship with the company.

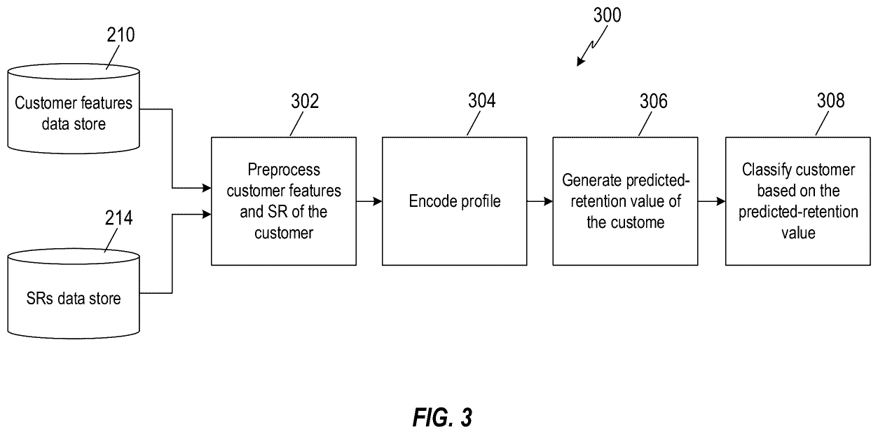

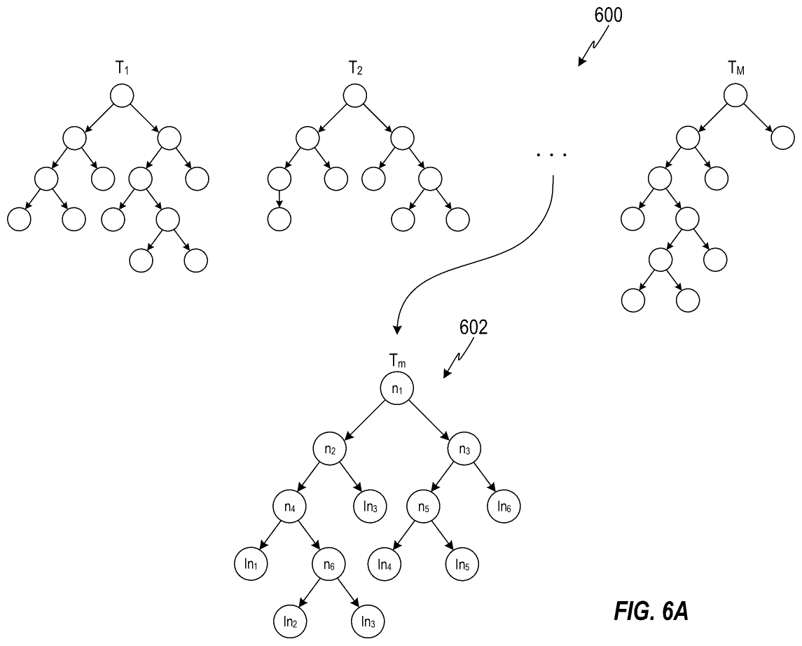

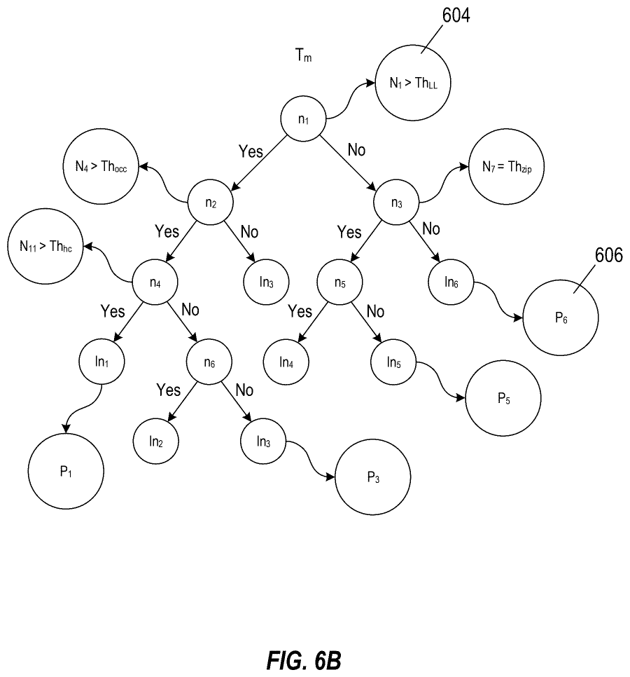

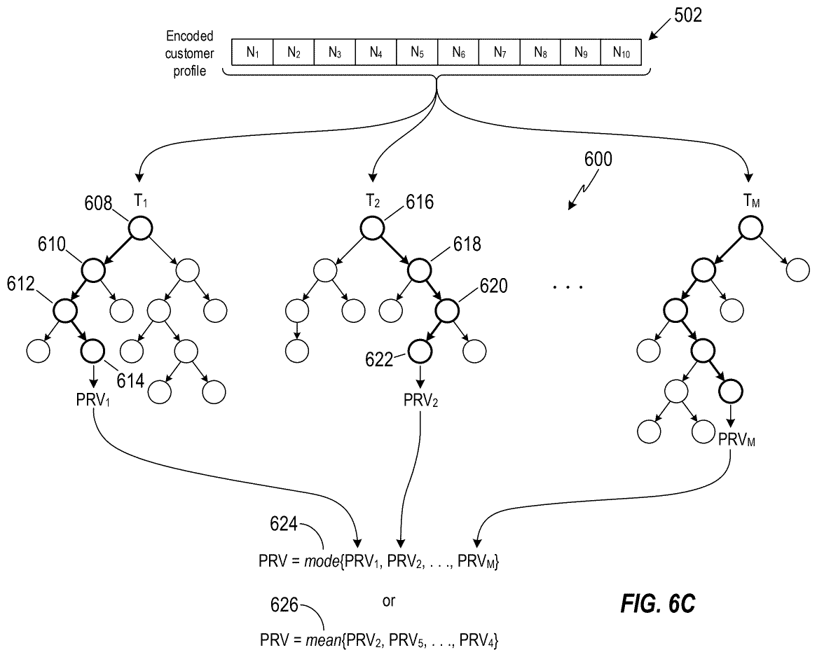

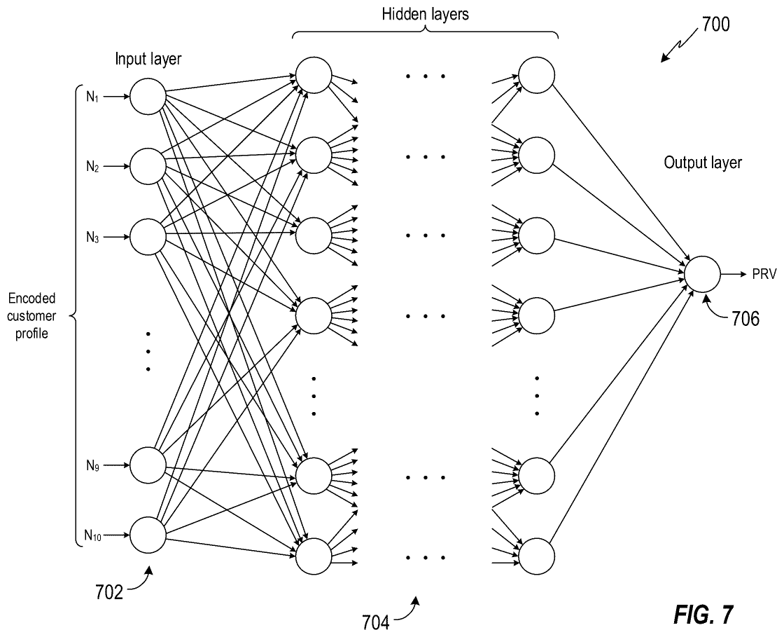

The customer retention engine 106 extracts a profile of the customer 112 from a customer profile database 118 and uses a trained classification model to obtain a probability (e.g., value between 0 and 1), called the “predicted-retention value (PRV),” of the customer 112 being retained based on the profile. The operations performed by the customer retention engine 106 are described below with reference to FIG. 3. The types of trained classification models and how the trained classification models are used to obtain a PRV from a profile is described below with reference to FIGS. 6A-7 and Equations (3)-(5). If the PRV of the customer 112 is less than a customer retention threshold (e.g., Thᵣₑₜ=0.07, 0.072, 0.1, 0.2 or 0.5), then the customer 112 is classified as a low-retention customer and is connected to the IVR marketing engine 108, which presents the customer 112 with an offer for one or more of a discounted product, subscription, and/or service. If the customer declines the offer, the customer relationship is cancelled. On the other hand, if the customer accepts the offer presented by the IVR marketing engine 108, then the customer retention engine 106 engages the call transfer engine 110.

The call transfer engine 110 electronically connects the electronic device of the customer 112 to a live customer service agent 120 who provides a personalized interaction with the customer 112 to try and retain the customer 112 based on the profile. If the PRV of the customer 112 is greater than the retention threshold (e.g., Thᵣₑₜ=0.072), then the customer 112 is classified as high-retention customer and the call transfer engine 110 transfers the customer 112 to a live customer service agent 120 who provides a personalized interaction with the customer 112 to try and retain the customer based on the profile.

The architecture 100 provides numerous technical advantages over traditional methods and systems for handling customers who submit a desire to cancel a subscription and/or service with a company. The architecture 100 uses a trained machine learning classification model to generate a PRV for the customer based on the customer's own profile. The PRV is a metric for determining how receptive the customer is to additional offers and/or retention efforts by a live customer service agent. The architecture 100 is automated, thereby eliminating the need for the far more costly and wasteful practice of sending every customer who submits a request to cancel a customer relationship with the company to a customer service agent who, in turn, presents the customer with a one-size-fits-all script.

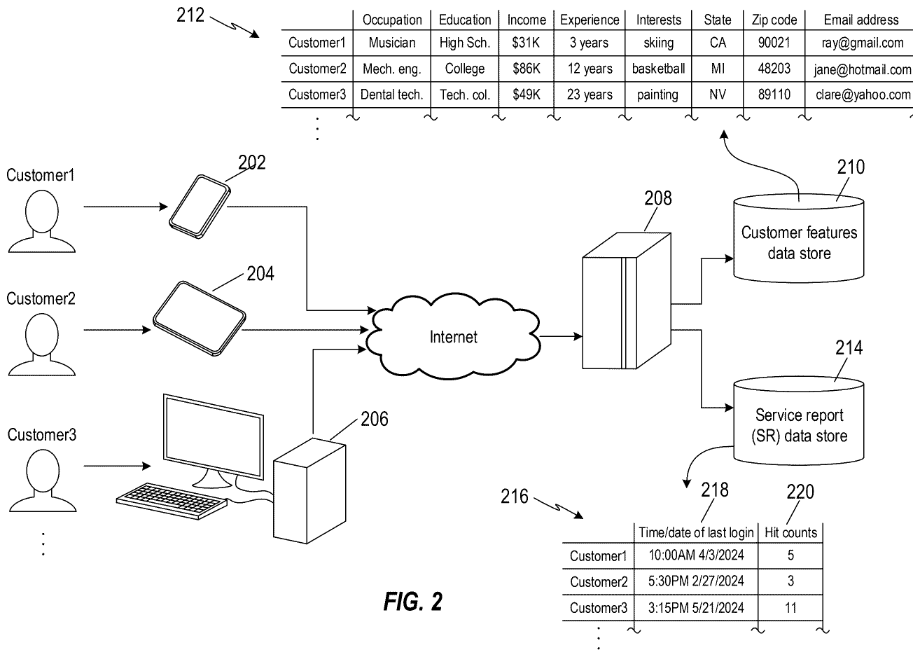

FIG. 2 depicts an example of creating a customer profile database from customer information received from various customers. When a customer engages with the company, the customer may be presented with a user interface that enables the customer to create an account and enter personal information via a web browser displayed on a device. FIG. 2 depicts an example of a Customer1 who inputs personal information via a web browser or company application displayed on a mobile device 202, a Customer2 who inputs personal information via a web browser displayed on a tablet 204, and a Customer3 who inputs personal information via a web browser displayed on a desktop computer 206. A computer server 208 stores the personal information as features in a customer features data store 210. A table 212 displays examples of various types of features that can be stored in the customer features data store 210 for each customer. In this example, the features include occupation, education, interests, income, state of residence, zip code, and email address for each customer. Other features that may be stored in the customer features data store 210 include various types of products, subscriptions, and services purchased by the customers.

Once a customer has created an account with the company, a customer service report (SR) is maintained for each customer in an SR data store 214. A table 216 displays examples of the various types of information recorded in the SR data store 214 for each customer. Column 218 records the last time and date of each customer's last login to their respective accounts. Column 220 records the number times each customer clicked on links (e.g., number of hits) within the website during their last login. For example, a customer visiting or clicking on a link equals one hit.

FIG. 3 depicts a flow diagram 300 of operations performed by the customer retention engine 106 for a customer who submits a request to cancel a customer relationship with the company as described above with reference to FIG. 1.

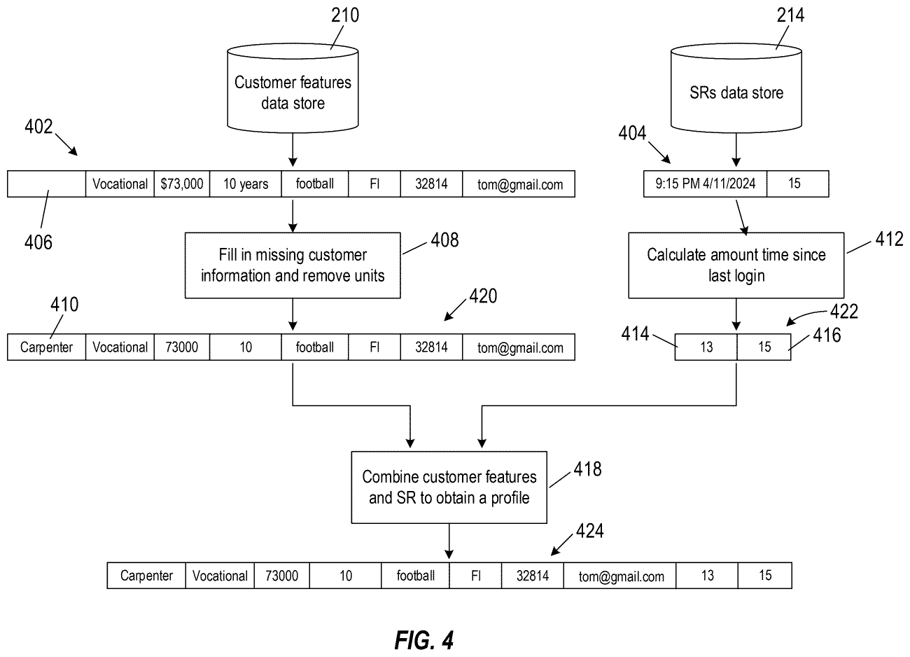

In block 302, the customer features associated with the customer are retrieved from the customer features data store 210 and SR data associated with the customer are retrieved from the SR data store 214 and preprocessed as described below with reference to FIG. 4 to obtain a profile for the customer. The profile can be stored in the customer profile database 118 of FIG. 1.

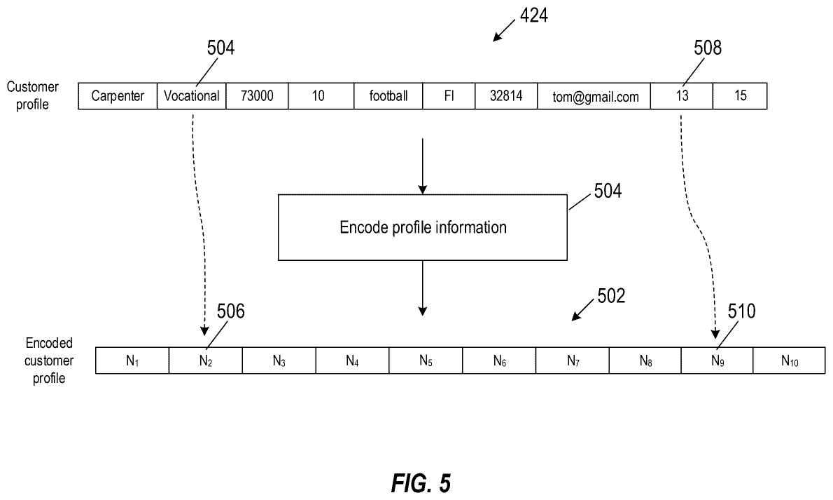

In block 304, the features of the profile are encoded in numerical values as described below with reference to FIG. 5 to obtain an encoded profile for the customer that can be stored in the customer profile database 118 of FIG. 1.

In block 306, a PRV is generated by a trained classification model based on the encoded profile as described below with reference to FIGS. 6A-7 and Equation (2). The classification model receives as input the encoded profile and outputs a PRV that corresponds to the probability, or likelihood, of retaining the customer associated with the encoded profile. The classification model is trained using supervised learning on sets of encoded profiles with corresponding retention values for each encoded profile. For example, each encoded profile in the set of training data has a corresponding retention value of 0, indicating the corresponding customer was not retained, or a corresponding retention value of 1, indicating the corresponding customer was retained.

In block 308, the customer is classified as a high-retention customer or a low-retention customer based on the corresponding PRV obtained in block 306. If the PRV is greater than the retention threshold, the customer is classified as a high-retention customer and connected to a live customer service agent for personalized service directed to retaining the customer as described above with reference to FIG. 1. On the other hand, if the PRV is less than the retention threshold, the customer is classified as a low-retention customer and the customer may be passed to IVR system that processes presents other offers to the customer and/or cancels of the customer relationship.

The operations performed by the customer retention engine 106 as described above with reference to FIG. 3 provide a technical solution to the technical problem of sending all customer cancelations to customer service agents and using one-size-fits-all scripts to try an retain the customers. The customer retention engine 106 use the classification model to predict which of the customers attempting to cancel the customer relationship are likely retainable by interactions with customer service agents who can provide personalized service and which of the customers are likely not retainable, which is a cost savings to the company in terms of labor and operating expenses.

### Preprocessing Customer Features and Service Reports

The preprocessing customer features and the SR of a customer who submits a desire to cancel a customer relationship in block 302 of FIG. 3 includes filling in missing features of the customer information and combining customer features with the SR of the customer to obtain a profile for the customer. Profiles of customers are created for each customer regardless of whether a customer submits a request to cancel.

FIG. 4 depicts an example of obtaining a profile for a customer as described above with reference to block 302 in FIG. 3. Customer features 402 of the customer are extracted from the customer features data store 210. A SR 404 of the customer is extracted from the SRs data store 214. In this example, the customer is missing a feature 406 that describes the customer's occupation.

In block 408, the preprocessing customer features in block 302 of FIG. 3 fills in missing features of the customer with the most likely features associated with the available customer features already recorded in the customer features data store 210. Missing numerical values of a profile, such as income, can be filled in with the median of customer incomes independent of other customer features. Missing non-numerical features can be filled in using an encoding model. For example, features, such as education, interest, past purchased items, current subscriptions, and current services used by the customer can be encoded into numerical values (e.g., floating point numbers) using a text-encoding model. The median of the numerical values is used to fill the missing value of a customer. In certain aspects, missing non-numerical features can be filled in with the median of the numerical values for the types of features followed by decoding the median value back into a non-numerical feature, which is used to predict the missing non-numerical feature of the customer. For example, in FIG. 4 the missing occupation of the customer is a carpenter 410. In certain aspects, features with higher correlations to save rates may have larger corresponding numerical values.

In block 412, the preprocessing customer features in block 302 of FIG. 3 calculates the amount of time in terms of hours or days since the customer last logged into his/her account and extracts the hit count during the last login. In this example, the latest login information 422 comprises the customer last logged into his/her account 13 days ago 414 and clicked on 15 links 416.

In block 418, the preprocessing customer features in block 302 of FIG. 3 combines the customer features 420 with the latest login information 422 to obtain a profile 424 of the customer.

The profile contains features that may be indicators of the customer receptiveness to being retained or not. For example, the state of residence feature is included because different states show different customer retention rates. The zip code feature is included because customers in certain zip codes have higher retention rates than customer in other zip codes. Occupation and education level can be indicators of whether a customer is likely to be retained or not. Customers at one education level may be more receptive to being retained than customers at a different education level services correspond to higher customer retention rates than customers who purchased less expensive subscriptions or services. Another indicator of a customer's receptiveness to being retained is the amount of time that has passed since the customer last logged into his/her account. Customers with longer amounts of time since their most recent login have lower retention rates than customers with shorter amounts of time since their most recent login. Hit counts are also an indicator of customer retention rates. Customers with larger hit counts have higher retention rates than customers with smaller hit counts.

Other features that may be included in the profile are dollar value of payment, number of different zip codes the customer has been in when logged in to the customer's account, document download count, currency used to make a purchase, Boolean value of whether the customer is a student (e.g., 0 customer is not a student and 1 customer is a student), number of payments past due, devices used to login to customer account (e.g., Macintosh®, iPhone®, iPad®, desktop PC), number of sections in customer's resume, number of paragraphs in customer's resume, number of characters in customer's resume, duration of most recent job, number of jobs in customer's resume, career gap, Boolean value for currently working or not working (e.g., 0 customer is unemployed and 1 customer is employed).

Encoding a Profile into an Encoded Profile

The encode profile represented by block 304 in FIG. 3 encodes the features of the profile obtained from the preprocessing engine in block 302 into numerical values denoted by Nᵢ, where the index i=1, . . . , K and K is the number features in the profile. Let N̅=(N₁, . . . , N_{K}) be a vector representation of the numerical values of an encoded profile of the customer. In certain aspects, the features can be encoded into vector representations using a text-embedding model (e.g., text-embedding-3).

FIG. 5 depicts an example of encoding the profile 424 obtained for the customer in FIG. 4 into an encoded profile 502 as described above with reference to block 304 in FIG. 3. Block 504 represents a process of encoding each feature of the profile 424 obtained in FIG. 4 into a corresponding numerical value. In this example, the profile 424 contains ten features that are encoded into 10 corresponding numerical values denoted by Nᵢ, where i=1, . . . , 10 (e.g., K=10), that form the encoded profile 502. In certain aspects, only features that represent words are encoded. For example, the word “vocational” 504 may be encoded into a numerical value represented by N₂ 506 and a numerical feature “13” 508 may be represented in the original numerical form by N₉ 510 (e.g., N₉=13).

### Generating a Predicted-Retention Value of the Customer

In certain aspects, the classification model used in block 306 of FIG. 3 can be a decision forest composed of plurality of decision trees. In certain aspects, the decision forest can be trained using the technique of bootstrap aggregating. Given a training set of encoded profiles and corresponding retention values (e.g., 0 is customer not retained and 1 is customer retained) bootstrap aggregating repeatedly selects a random sample with replacement of the encoded profiles and correspond retention values to fit a decision tree to the sample. This process of random sampling with replacement is repeated M times to give M number of decision trees in the decision forest. The number of decision trees in the decision tree forest can range from about 6,000 to about 20,000 decision trees. For example, the decision tree forest can contain about 7,000 decision trees.

In certain aspects, the M decisions trees of the decision forest can be trained using the technique of extreme gradient boosting (XGBoost), which is a scalable distributed gradient-boosted decision tree machine learning library. Each tree in XGBoost is trained to correct the errors made by previous decision trees. XGBoost begins with a weak learner, typically a simple decision tree, and gradually adds more trees that focus on the residuals (errors) of the previous model. The decision trees in XGBoost are typically shallow (small depth) because each tree is designed to make small improvements. The final model in XGBoost is an additive combination of the decision trees. In certain aspects, the prediction can be made by summing the predictions from the decision trees, each weighted by a learning rate. XGBoost includes regularization terms to control the complexity of the model and prevent overfitting (e.g., by penalizing deeper trees or trees that fit the residuals too closely).

FIGS. 6A-6C depict an example of using a decision forest to obtain a PRV of the customer who submitted a request to cancel a customer relationship. FIG. 6A depicts an example decision forest 600 composed of M decision trees denoted by Tₘ, where the index m=1, . . . , M. Each decision tree is composed of a root node (e.g., parent node), internal nodes (e.g., child nodes), and leaf nodes. The root node and the internal nodes correspond to a test (e.g., decision to be made) of a feature that split each encoded profile in subsets based on the numerical value of a corresponding feature. FIG. 6A depicts an enlargement of an example decision tree Tₘ 602. The decision tree Tₘ contains a root node and five internal nodes denoted by nᵢ, where the index i=1, . . . , 6. The root and each internal node represents a test with respect the numerical value of a corresponding feature in the encoded profile. The decision tree Tₘ contains six leaf nodes denoted by lnⱼ, where the index j=1, . . . 6. Each leaf node corresponds a PRV. Each path from the root node to a leaf node is a classification rule for assigning a PRV to the encoded profile.

FIG. 6B depicts an example of tests and corresponding thresholds for certain nodes in the example decision tree Tₘ 602. In this example, root node n₁ represents a test 604 in with the numerical value N₁ that represents the “occupation” feature of a customer is compared to a threshold value Th_{LL}. If the numerical value N₁ satisfies the test of the root node n₁, a test at internal node n₂ compares the numerical value N₄ of the number of years of experience feature to a threshold value Th_{occ}. Otherwise, if the numerical value N₁ does not satisfies the test 604 of the root node n₁, a test at internal node n₃ compares the numerical value N₇ that corresponds to the zip code feature to a threshold value Th_{zip}. The leaf nodes represent the PRV associated with the customer. For example, if N₁≤Th_{LL} at the root node n₁ and N₇≠Th_{zip} at node n₃, the PRV of the customer for the decision tree Tₘ 602 is the probability P₆ 606 at leaf node ln₆ (e.g., PRVₘ=P₆).

The PRV of the customer for the decision forest is determined by traversing each of the decision trees in the decision forest with the encoded profile as described above with reference to FIG. 6B to obtain a PRV for each decision tree. In certain aspects, the PRV of the customer is given by the mode of the PRVs obtained from the decision trees of the decision forest. In other aspects, the PRV of the customer is the mean of the PRVs obtained from decision trees of the decision forest.

FIG. 6C depicts an example of traversing three decision trees in the decision forest 600 with the encoded profile 502 to obtain a corresponding PRV for each decision tree. Highlighted nodes in each decision tree represent a path in which numerical values of certain features are compared to tests at nodes that lead to a PRV. Each path that leads to a PRV corresponds to a different set of nodes and tests applied to a subset of numerical values of the encoded profile 502. For example, highlighted nodes 608, 610, and 612 of decision tree T₁ represent three tests where three numerical values of corresponding features of the encoded profile are compared to the thresholds, leading to a PRV₁ 614. Highlighted nodes 616, 618, and 620 represent three tests of decision tree T₂ where three numerical values of a different set of corresponding features of the encoded profile are compared to the thresholds, leading to a PRV₂ 622.

In certain aspects, the PRV of the customer is given by the mode 624 of the set of PRVs obtained from traversing each of the decision trees of the decision forest 600. In certain aspects, the PRV of the customer is given by the mean 626 of the set of PRVs obtained from traversing each of the decision trees of the decision forest 600.

In certain aspects, the customer can be assigned a classification label that classifies the customer as a high-retention customer or a low-retention customer based on the corresponding encoded profile as follows:

$$Label ( \overline{N} ) = \{ \begin{matrix}1 & if PRV \geq {Th}_{ret} \\ 0 & if PRV < {Th}_{ret}\end{matrix} \qquad Equation ( 1 )$$

where
Label(N̅)=1 means the customer is a high-retention customer;
Label(N̅)=0 means the customer is a low-retention customer; and
Thᵣₑₜ=0.5, 0.6, 0.7, 0.8, or 0.9.

In certain aspects, the classification model used in block 306 of FIG. 3 can be a single decision tree model trained sets of encoded profiles and corresponding retention values (e.g., 0 is customer not retained and 1 is customer retained). The single decision tree model is composed of a root node (e.g., parent node), internal nodes (e.g., child nodes), and leaf nodes that correspond to PRVs for the customer. The root node and the internal nodes correspond to a test (e.g., decision to be made) of a feature that split each encoded profile in subsets based on the numerical value of a corresponding feature. The single decision tree model is built by recursively splitting the data based on the feature that provides the maximum information gain (in classification) or variance reduction (in regression) at each branch of the tree. The tree continues to grow until it either classifies the training data or reaches a specified stopping criterion, such as maximum depth. The decision-tree model is traversed with the encoded profile, as described above with reference to FIG. 6B, to obtaining the PRV of the customer. The customer is classified as a high-retention customer or a low-retention customer as described above with reference to Equation (1).

In certain aspects, the classification model used in block 306 of FIG. 3 can be a neural network. The neural network is trained on sets of encoded profiles and corresponding retention values (e.g., 0 is customer not retained and 1 is customer retained) using forward and backward propagation to minimize a loss function. The neural network may have an input layer with K nodes for receiving the numerical values Nᵢ, where i=1, . . . , K, of the encoded profile, a number of hidden layers, and an output layer with a single node that corresponds to the PRV.

FIG. 7 depicts an example of using a neural network 700 to obtain a PRV for the customer who submitted a request to cancel a subscription or service. In this example, the neural network 700 includes an input layer 702 with 10 input nodes for receiving the 10 numerical values of the features in the encoded profile 502. The neural network 700 includes two or more fully connected hidden layers 704. In this example, the neural network 700 includes an output layer 706 composed of a single output node PRV.

In certain aspects, the customer can be assigned a classification label that classifies the customer as a high-retention customer or a low-retention customer based on the corresponding encoded profile as follows:

$$Label ( \overline{N} ) = \{ \begin{matrix}1 & if PRV \geq {Th}_{ret} \\ 0 & if PRV < {Th}_{ret}\end{matrix} \qquad Equation ( 2 )$$

where Label(N̅)=1 means the customer is a high-retention customer and the Label(N̅)=0 means the customer is a low-retention customer.

In certain aspects, the classification model used in block 306 of FIG. 3 can be a logistics regression model. Logistic regression is a classification technique in which the classification model is a sigmoid function classifier taken from values between 0 and 1:

$${PRV}_{\overline{β}} ( \overline{N} ) = \frac{1}{1 + {e}^{- {\overline{β}}^{T} \overline{N}}} \qquad Equation ( 3 )$$

where
N̅=(N₁, . . . , N_{K}) is a vector representation of the numerical values of encoded profile of the customer; and
β̅=(β₀, . . . , β_{K}) is a vector representation of regression coefficients.

In certain aspects, the classification model in Equation (3) can be used to assign a classification label to classify the customer as a high-retention customer or a low-retention customer based on the corresponding encoded profile as follows:

$$Label ( \overline{N} ) = \{ \begin{matrix}1 & if {PRV}_{\overline{β}} ( \overline{N} ) \geq {Th}_{ret} \\ 0 & if {PRV}_{\overline{β}} ( \overline{N} ) < {Th}_{ret}\end{matrix} \qquad Equation ( 4 )$$

where Label(N̅)=1 means the customer is a high-retention customer and the Label(N̅)=0 means the customer is a low-retention customer. In another aspect, the classification model in Equation (2) can be simplified to

$$Label ( \overline{N} ) = \{ \begin{matrix}1 & if {\overline{β}}^{T} \overline{N} \geq 0 \\ 0 & if {\overline{β}}^{T} \overline{N} < 0\end{matrix} \qquad Equation ( 5 )$$

The components of the vector β̅ are determined by minimizing a cost function given by:

$$J ( \overline{β} ) = \frac{1}{u} {\sum }_{i = 1}^{u} Cost ( {PRV}_{\overline{β}} ( {\overline{N}}_{i} ) , {p}_{i} ) \qquad Equation ( 6 )$$

where
u is the number of training sets of encoded profiles;
N̅ᵢ is the encoded profile for an i-th customer;
pᵢ=1 if the i-th customer is retained;
pᵢ=0 if the i-th customer is not retained; and

$$Cost ( {PRV}_{\overline{β}} ( {\overline{N}}_{i} ) , {p}_{i} ) = \{ \begin{matrix}- log ( PRV ( {PRV}_{\overline{β}} ( {\overline{N}}_{i} ) ) ) & if {p}_{i} = 1 \\ - log ( 1 - PRV ( {PRV}_{\overline{β}} ( {\overline{N}}_{i} ) ) ) & if {p}_{i} = 0\end{matrix}$$

Minimizing the cost function in Equation (6) gives the vector β̅ used in Equation (1).

### Example Method for Predicting Retention of a Customer

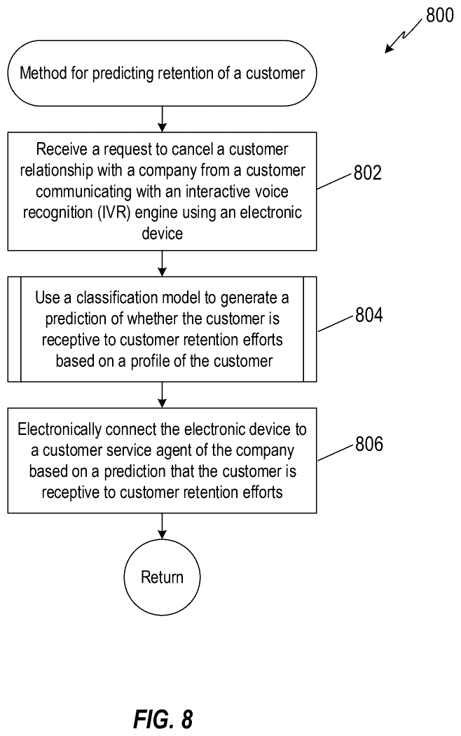

FIG. 8 depicts a flow diagram 800 of a method for predicting retention of a customer. The method overcomes the technical problems associated with the traditional approach of sending every customer who submits a request to cancel a subscription or service with a company to a customer service agent.

In block 802, a request to cancel a customer relationship with a company is received from a customer communicating with an interactive voice response (IVR) engine using an electronic device.

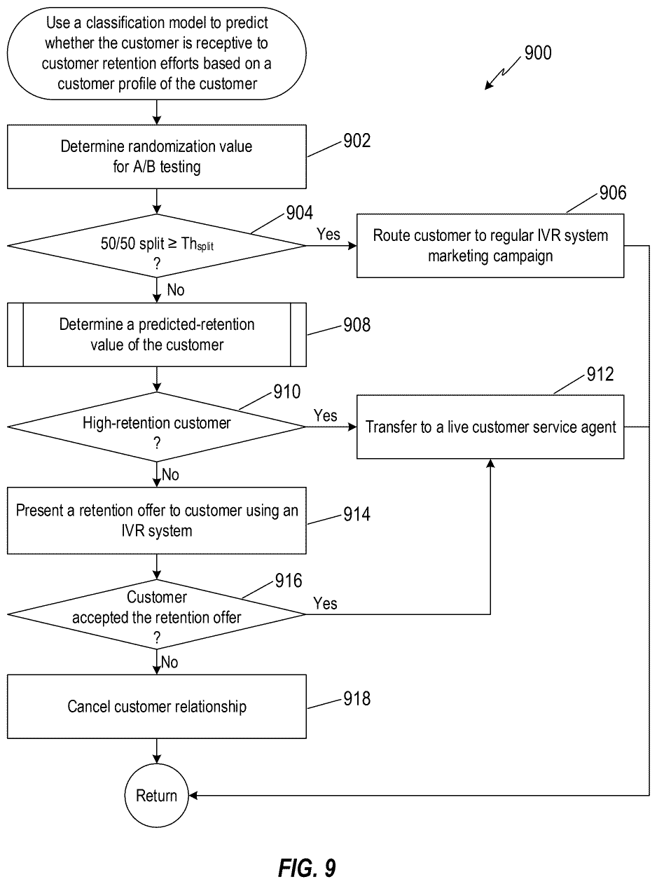

In block 804, a “use a classification model to generate a prediction of whether the customer is receptive to customer retention efforts based on a profile of the customer” is performed. An example implementation of this process is described below with reference to FIG. 9.

In block 806, the electronic device is electronically connected to a customer service agent of the company based on the prediction that the customer is receptive to customer retention efforts.

FIG. 9 depicts a flow diagram 900 of the process in block 804 of FIG. 8.

In block 902, a randomized value between 0 and 1 is generated and assigned to a customer who submits a request to cancel a relationship with a company. A/B testing is performed to determine whether to rout the customer to a customer service agent or to the classification model.

In block 904, if the randomized value assigned to the customer is less than a split threshold (e.g., Thₛₚₗᵢₜ=0.5), the customer is routed to block 806. Otherwise, control flows to block 908.

In block 906, the customer is connected to an IVR system marketing campaign that presents the customer with discounts on subscriptions and/or services as described above with reference to FIG. 1.

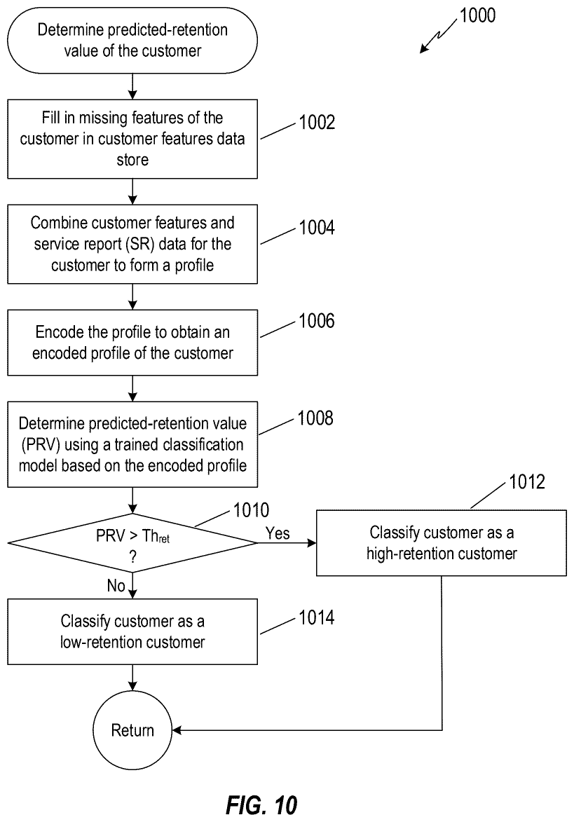

In block 908, a “determine a predicted-retention value (PRV) of the customer” is performed. An example implementation of this process is described below with reference to FIG. 10.

In block 910, if the PRV output from block 908 indicates the customer is a high-retention customer, control flows to block 912. Otherwise, control flows to block 914.

In block 912, the customer is transferred to a live customer service agent. The service agent provides the customer personalized offers to retain the customer as described above with reference to FIG. 1.

In block 914, the customer has been identified as a low-retention customer and is presented with a discounted subscription and/or services using an IVR system as described above with reference to FIG. 1.

In block 916, if the customer accepts the offer presented by the IVR system in block 914, control flows to block 912. Otherwise, control flows to block 918.

In block 918, the customer relationship with the company is cancelled.

FIG. 10 depicts a flow diagram of an example implementation of the “determine PRV of the customer” described in block 908.

In block 1002, features that are missing from the customer features of the customer in the customer features data store are filled in as described above with reference to FIG. 4.

In block 1004, customer features and SR data for the customer are combined to form a profile for the customer as described above with reference to FIG. 4.

In block 1006, the features of the profile are numerically encoded to obtain an encoded profile of the customer as described above with reference to FIG. 5.

In block 1008, a PRV for the customer is determined using a trained classification model based on the encoded profile as described above with reference FIGS. 6A-7 and Equations (1)-(5).

In block 1010, if the PRV is greater than a retention threshold (e.g., Thᵣₑₜ=0.5, 0.6, or 0.7), control flows to block 912. Otherwise, control flows to block 914.

In block 1012, the customer is classified as a high-retention customer.

In block 1014, the customer is classified as a low-retention customer.

The “determine predicted-retention value (PRV) of the customer” process in block 908 and performed in FIG. 10 provides technical advantages over traditional methods for handling customers who submit a desire to cancel a customer relationship with a company. The process in FIG. 10 uses a trained machine learning classification model, as described above, to generate a PRV for the customer based on the profile of the customer. The PRV is a prediction of whether the customer is receptive to retention efforts by a live customer service agent.

The process of FIGS. 8-10 is an automated process that uses the trained machine learning classification model to eliminate the far more costly and wasteful practice of sending every customer who submits a request to cancel a customer relationship to a customer service agent who presents the customer with a one-size-fits-all script.

### Example Computing Device

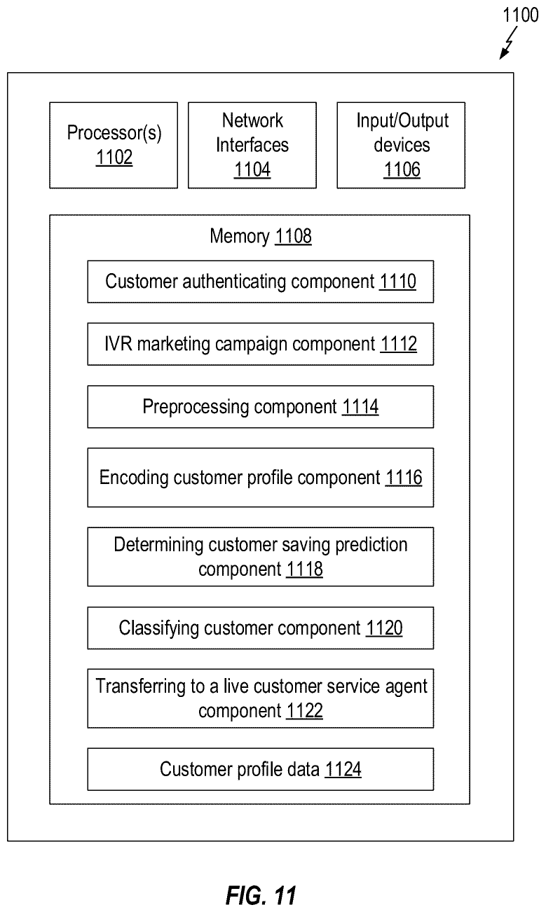

FIG. 11 schematically depicts an example computing device 1100, according to one or more embodiments shown and described herein. As illustrated, the computing device 1100 includes one or more processors 1102, one or more network interfaces 1104, input/output devices 1106, and memory 1108 and performs the method of FIGS. 8, 9, and 10.

Generally, the one or more processors 1102 are configured to execute computer-executable instructions (e.g., software code) to perform various functions, as described herein.

The one or more network interfaces 1104 generally provides data access to any sort of data network, including personal area networks (PANs), local area networks (LANs), wide area networks (WANs), the Internet, and the like.

The input/output devices 1106 generally provide means for providing data to and from the online document creation system parallel interaction user interface system, such as via connection to computing device peripherals, including user interface peripherals.

The memory 1108 is configured to store various types of components and data.

In this example, memory 1108 includes a customer authenticating components 1110, an IVR marketing campaign component 1112, preprocessing component 1114, encoding customer profile component 1116, determining customer saving prediction component 1118, classifying customer component 1120, transferring to live customer service agent component 1122, and customer profile data 1124.

Customer authenticating components 1110 is configured to perform customer authentication of the customer as described above with reference to customer IVR engine 104 in FIG. 1.

IVR marketing campaign component 1112 is configured to perform present a customer that has been identified as a low-retention customer with offers for product, subscription, or a service

Preprocessing component 1114 is configured to retrieve customer features from a customer features data store 210 and fill in missing customer features in block 408 as described above with reference to FIG. 4. The preprocessing component 1114 also retrieves an SR of the customer from the SRs data store 214 and in block 412 of FIG. 4 calculates the amount of time that has passed since the customer last logged into their account as described above with reference to FIG. 4. The preprocessing component 1114 combines the customer features, the amount of time since the customer last logged in and the number of hits to form a profile for the customer as described above with reference to FIG. 4.

Encoding customer profile component 1116 is configured to encode the features of the profile into numerical values of an encoded profile as described above with reference to FIG. 5.

Determining customer saving prediction component 1118 is configured to compute a PRV for a customer who submits a request to cancel a customer relationship with the company based on the encoded profile. In certain aspects, the determine customer saving prediction component 1118 can compute the PRV using a decision forest as described above with reference to FIGS. 6A-6C. In certain aspects, the determine customer saving prediction component 1118 can compute the PRV using a neural network as described above with reference to FIG. 7. In certain aspects, the determine customer saving prediction component 1118 can compute the PRV using a sigmoid function classifier that has been trained using logistic regression as described above with reference to Equations (3)-(5).

Classifying customer component 1120 is configured to classify the customer as a high-retention customer or a low-retention customer based on the PRV output from the determining customer saving prediction component 1118. In certain aspects, the classifying customer component 1120 classifies the customer as described above with reference to Equation (1). In certain aspects, the classifying customer component 1120 classifies the customer as described above with reference to Equation (2). In certain aspects, the classifying customer component 1120 classifies the customer as described above with reference to Equation (4) or (5).

Transferring to a live customer service agent component 1122 is configured to transfer the customer to a live customer agent when the customer has been classified as high-retention customer as described above with reference to FIG. 1.

Customer profile data 1124 comprises the profile data and the encoded profile data obtained as described above with reference to FIG. 4.

### Example Clauses

Implementation examples are described in the following numbered clauses:

Clause 1: A computer-implemented method, comprising: obtaining a request to cancel a customer relationship with a company from a customer communicating with an interactive voice recognition (IVR) engine using an electronic device; using a classification model to generate a prediction of whether the customer is receptive to customer retention efforts based on a profile of the customer; and electronically connecting the electronic device of the customer to a customer service agent of the company based on a prediction that the customer is receptive to customer retention efforts.

Clause 2: The method of Clause 1, wherein using the classification model to generate the prediction of the customer being receptive to customer retention efforts comprises obtaining the profile from features of the customer stored in a customer features data store and a service report of the customer stored in a service reports data store.

Clause 3: The method of any one of Clause 1-2, wherein obtaining the profile comprises: filling in missing customer features of the customer in the customer features data store; determining an amount of time since the customer last logged into an account with the company from the service report; determining a number of hits the customer had on links within a website of the company during an amount of time the customer last logged into the account; and combining the customer features of the customer, the amount of time, and the number of hits to form the profile.

Clause 4: The method of any one of Clause 1-3, wherein using a classification model to predict whether the customer is receptive to customer retention efforts comprises: encoding customer features of the profile into numerical values to obtain an encoded profile; traversing a decision-tree model with the encoded profile; and obtaining, as output from the decision-tree model, a predictive-retention value (PRV) of the customer, wherein each internal node of the decision-tree model corresponds to a test of a customer feature in a customer features data store and a test of service report values of a service reports data store and each leaf node of the decision-tree model corresponds a different PRV.

Clause 5: The method of any one of Clause 1-4, wherein using a classification model to predict whether the customer is receptive to customer retention efforts comprises: encoding customer features of the profile into numerical values to obtain an encoded profile; traversing each decision tree of a decision forest with the encoded profile; obtaining, as output from each decision tree of the decision forest, a plurality of PRVs; and determining the PRV of the customer as a mode or a mean of the plurality of PRVs to identify the customer as a high-retention customer or a low-retention customer, wherein internal nodes of the decision trees in the decision forest correspond to tests of customer features in the customer features data store and to tests of service report values of a service reports data store and leaf nodes of the decision trees corresponds to different PRVs.

Clause 6: The method of any one of Clause 1-5, wherein using a classification model to predict whether the customer is receptive to customer retention efforts comprises: encoding customer features of the profile into numerical values to obtain an encoded profile; inputting the encoded profile to a neural network (NN); and obtaining, as output from the NN, a PRV of the customer.

Clause 7: The method of any one of Clause 1-6, wherein using a classification model to predict whether the customer is receptive to customer retention efforts comprises: encoding customer features of the profile into numerical values to obtain an encoded profile; inputting the encoded profile to a sigmoid function classifier with regression coefficients trained using logistic regression; and obtaining, as output from the sigmoid function classifier, a PRV of the customer.

Clause 8: The method of any one of Clause 1-7, further comprising: further comprising: electronically connecting the electronic device of the customer to an IVR marketing campaign engine to present the customer with a retention offer based on a prediction that the customer is not receptive to customer retention efforts; and electronically connecting the electronic device of the customer to the customer service agent in response to the customer accepting the retention offer using the IVR.

Clause 9: The method of any one of Clause 1-8, further comprising: electronically connecting the electronic device of the customer to an IVR marketing campaign engine to present the customer with a retention offer based on a prediction that the customer is not receptive to customer retention efforts; and cancelling the customer relationship in response to the customer rejecting the retention offer.

Clause 10: A processing system, comprising: a memory comprising computer-executable instructions; and a processor configured to execute the computer-executable instructions and cause the processing system to perform a method in accordance with any one of Clauses 1-9.

Clause 11: A processing system, comprising means for performing a method in accordance with any one of Clauses 1-9.

Clause 12: A non-transitory computer-readable medium storing program code for causing a processing system to perform the steps of any one of Clauses 1-9.

Clause 13: A computer program product embodied on a computer-readable storage medium comprising code for performing a method in accordance with any one of Clauses 1-9.

### ADDITIONAL CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
obtaining a request to cancel a customer relationship with a company from a customer communicating with an interactive voice recognition (IVR) engine using an electronic device;
using a classification model to generate a prediction of whether the customer is receptive to customer retention efforts based on a profile of the customer; and
electronically connecting the electronic device of the customer to a customer service agent of the company based on a prediction that the customer is receptive to customer retention efforts.

2. The method of claim 1, wherein using the classification model to generate the prediction of the customer being receptive to customer retention efforts comprises obtaining the profile from features of the customer stored in a customer features data store and a service report of the customer stored in a service reports data store.

3. The method of claim 2, wherein obtaining the profile comprises:
determining an amount of time since the customer last logged into an account with the company from the service report;
determining a number of hits the customer had on links within a website of the company during an amount of time the customer last logged into the account; and
combining the customer features of the customer, the amount of time, and the number of hits to form the profile.

4. The method of claim 1, wherein using a classification model to predict whether the customer is receptive to customer retention efforts comprises:
encoding customer features of the profile into numerical values to obtain an encoded profile;
traversing a decision-tree model with the encoded profile; and
obtaining, as output from the decision-tree model, a predictive-retention value (PRV) of the customer,
wherein each internal node of the decision-tree model corresponds to a test of a customer feature in a customer features data store and a test of service report values of a service reports data store and each leaf node of the decision-tree model corresponds a different PRV.

5. The method of claim 1, wherein using a classification model to predict whether the customer is receptive to customer retention efforts comprises:
encoding customer features of the profile into numerical values to obtain an encoded profile;
traversing each decision tree of a decision forest with the encoded profile;
obtaining, as output from each decision tree of the decision forest, a plurality of PRVs; and
determining the PRV of the customer as a mode or a mean of the plurality of PRVs to identify the customer as a high-retention customer or a low-retention customer,
wherein internal nodes of the decision trees in the decision forest correspond to tests of customer features in the customer features data store and to tests of service report values of a service reports data store and leaf nodes of the decision trees corresponds to different PRVs.

6. The method of claim 1, wherein using a classification model to predict whether the customer is receptive to customer retention efforts comprises:
encoding customer features of the profile into numerical values to obtain an encoded profile;
inputting the encoded profile to a neural network (NN); and
obtaining, as output from the NN, a PRV of the customer.

7. The method of claim 1, wherein using a classification model to predict whether the customer is receptive to customer retention efforts comprises:
encoding customer features of the profile into numerical values to obtain an encoded profile;
inputting the encoded profile to a sigmoid function classifier with regression coefficients trained using logistic regression; and
obtaining, as output from the sigmoid function classifier, a PRV of the customer.

8. The method of claim 1, further comprising:
electronically connecting the electronic device of the customer to an IVR marketing campaign engine to present the customer with a retention offer based on a prediction that the customer is not receptive to customer retention efforts; and
electronically connecting the electronic device of the customer to the customer service agent in response to the customer accepting the retention offer using the IVR.

9. The method of claim 1, further comprising:
electronically connecting the electronic device of the customer to an IVR marketing campaign engine to present the customer with a retention offer based on a prediction that the customer is not receptive to customer retention efforts; and
cancelling the customer relationship in response to the customer rejecting the retention offer.

10. A processing system, comprising:
one or more memories comprising computer-executable instructions; and
one or more processors configured to execute the computer-executable instructions and cause the processing system to:
obtain a request to cancel a customer relationship with a company from a customer communicating with an interactive voice recognition (IVR) engine using an electronic device;
use a classification model to generate a prediction of whether the customer is receptive to customer retention efforts based on a profile of the customer; and
electronically connect the electronic device of the customer to a customer service agent of the company based on a prediction that the customer is receptive to customer retention efforts.

11. The processing system of claim 10, wherein to use the classification model to generate the prediction of the customer being receptive to customer retention efforts, the one or more processors configured to cause the processing system to obtain the profile from features of the customer stored in a customer features data store and a service report of the customer stored in a service reports data store.

12. The processing system of claim 10, wherein to obtain the profile, the one or more processors are configured to cause the processing system to:
determining an amount of time since the customer last logged into an account with the company from a service report;
determining a number of hits the customer had on links within a website of the company during an amount of time the customer last logged into the account; and
combining the customer features of the customer, the amount of time, and the number of hits to form the profile.

13. The processing system of claim 10, wherein to use a classification model to generate the prediction of whether the customer is receptive to customer retention efforts, the one or more processors are configured to cause the processing system to:
encode customer features of the profile into numerical values to obtain an encoded profile;
traverse a decision-tree model with the encoded profile; and
obtain, as output from the decision-tree model, a predictive-retention value (PRV) of the customer, wherein each internal node of the decision-tree model corresponds to a test of a customer feature in a customer features data store and a test of service report values of a service reports data store and each leaf node of the decision-tree model corresponds a different PRV.

14. The processing system of claim 10, wherein to use a classification model to generate the prediction of whether the customer is receptive to customer retention efforts, the one or more processors are configured to cause the processing system to:
encode customer features of the profile into numerical values to obtain an encoded profile;
traverse each decision tree of a decision forest with the encoded profile;
obtain, as output from each decision tree of the decision forest, a plurality of PRVs; and
determine the PRV of the customer as a mode or a mean of the plurality of PRVs to identify the customer as a high-retention customer or a low-retention customer, wherein internal nodes of the decision trees in the decision forest correspond to tests of customer features in the customer features data store and to tests of service report values of a service reports data store and leaf nodes of the decision trees corresponds to different PRVs.

15. The processing system of claim 10, wherein to use a classification model to generate the prediction of whether the customer is receptive to customer retention efforts, the one or more processors are configured to cause the processing system to:
encode customer features of the profile into numerical values to obtain an encoded profile;
input the encoded profile to a neural network (NN); and
obtain, as output from the NN, a PRV of the customer.

16. The processing system of claim 10, wherein to use a classification model to generate the prediction of whether the customer is receptive to customer retention efforts, the one or more processors are configured to cause the processing system to:
encode customer features of the profile into numerical values to obtain an encoded profile;
input the encoded profile to a sigmoid function classifier with regression coefficients trained using logistic regression; and
obtain, as output from the sigmoid function classifier, a PRV of the customer.

17. The processing system of claim 10, wherein the one or more processors are configured to cause the processing system to:
electronically connect the electronic device of the customer to an IVR marketing campaign engine to present the customer with a retention offer based on a prediction that the customer is not receptive to customer retention efforts; and
electronically connect the electronic device of the customer to the customer service agent in response to the customer accepting the retention offer using the IVR.

18. The processing system of claim 10, wherein the one or more processors are configured to cause the processing system to:
electronically connect the electronic device of the customer to an IVR marketing campaign engine to present the customer with a retention offer based on a prediction that the customer is not receptive to customer retention efforts; and
cancel the customer relationship in response to the customer rejecting the retention offer.

19. An apparatus comprising:
a customer interactive voice recognition (IVR) engine configured to authenticate an identify of a customer of a company and to guide the customer through a series of menu options or questions that detect a request to cancel a customer relationship with the company via an electronic device of the customer, wherein the electronic device is in electronic communication with the apparatus;
a customer retention engine configured to, in response to the customer IVR engine detecting a request to cancel the customer relationship by the company, use a classification model to predict whether the customer is receptive to customer retention efforts based on information the company has retained about the customer; and
a call transfer engine configured to electronically connect the electronic device of the customer to a customer service agent of the company in response to a prediction that the customer is receptive to customer retention efforts, thereby enabling the customer to communicate directly with the customer service agent.

20. The apparatus of claim 19, wherein the customer retention engine is configured to:
extract a profile of the customer from a customer features data store and a service reports data store;
use the classification model to obtain a predicted-retention value that identifies the customer as a high-retention customer or a low-retention customer based on the customer information;
electronically connect the customer to a customer service agent of the company in response to the customer being identified as the high-retention customer; and
cancel the service in response to the customer being identified as the low-retention customer and the customer having rejected a retention offer.
